(19) United States
(12) Patent Application Publication
(10) Pub. No.: US 2018/0060578 A1
(43) Pub. Date: Mar. 1, 2018

(54) MAGNETIC STRIPE CARD ANTI-HACKING METHOD AND DEVICE

(71) Applicant: MFS CORPORATION, Seoul (KR)

(72) Inventor: Dong Gyun Kim, Seoul (KR)

(21) Appl. No.: 15/687,255

(22) Filed: Aug. 25, 2017

(30) Foreign Application Priority Data
Aug. 29, 2016 (KR) 10-2016-0110090

(51) Int. Cl. G06F 21/56; G07F 19/00

(52) U.S. Cl. CPC G06F 21/56; G07F 19/2055

(57) ABSTRACT

A magnetic stripe (MS) card anti-hacking device provided in a financial service apparatus including an MS card reader includes a sensor detecting whether an abnormal attachment is attached to a card insertion portion of the MS card reader, a sensor controller determining whether the abnormal attachment is attached to the card insertion portion by processing a signal received from the sensor, an anti-skimming (jamming) driver generating a jamming signal to interfere with replication of an MS card when the abnormal attachment is attached to the card insertion portion, and a jamming signal output portion radiating the jamming signal toward the abnormal attachment.

### CROSS-REFERENCE TO RELATED APPLICATION

This application claims the benefit of Korean Patent Application No. 10-2016-0110090, filed on Aug. 29, 2016, in the Korean Intellectual Property Office, the disclosure of which is incorporated herein in its entirety by reference.

### BACKGROUND

### 1. Field

One or more embodiments relate to a method of preventing hacking of a magnetic stripe (MS) card and a device using the method.

### 2. Description of the Related Art

Financial automation devices such as automated teller machines (ATM) are becoming popular in everyday life and are widely installed in commercial or residential areas. The financial automation devices have the advantage of providing financial services regardless of time and place, but they are easily exposed to hacking crimes. Particularly, magnetic stripe (MS) cards are very vulnerable to hacking. For example, an ATM has an embedded MS card reader. The MS card reader has a magnetic head for magnetically reading card information from the MS.

The disadvantage of the MS card is that it can be easily replicated. Most replica devices are installed in the bezel (card insertion part) of the card reader, and read the card information from the MS when the card is inserted in the bezel.

In order to solve such a hacking problem, a method has been proposed in which a sensor is installed in a bezel portion to detect when an abnormal attachment is attached to the bezel, and the abnormal attachment is forcefully detached from the bezel by a mechanical device. However, this method has a problem in that card duplication is unavoidable if the abnormal attachment, which is a hacking device, is not detached.

Such card duplication may occur not only in the financial automation devices but also in card payment terminals. Therefore, it is urgent to provide a means for preventing MS card hacking more completely for all financial service apparatuses including MS card readers.

### PRIOR ART DOCUMENTS

1. KR10-2010-0072606 A

2. KR10-2016-0068579 A

### SUMMARY

One or more embodiments include an apparatus and method for effectively preventing hacking of a magnetic stripe (MS) card by blocking MS card information hacking.

Additional aspects will be set forth in portion in the description which follows and, in part, will be apparent from the description, or may be learned by practice of the presented embodiments.

According to one or more embodiments, a magnetic stripe (MS) card anti-hacking device provided in a financial service apparatus including an MS card reader includes a sensor detecting whether an abnormal attachment is attached to a card insertion portion of the MS card reader, a sensor controller determining whether the abnormal attachment is attached to the card insertion portion by processing a signal received from the sensor, an anti-skimming (jamming) driver generating a jamming signal to interfere with replication of an MS card when the abnormal attachment is attached to the card insertion portion, and a jamming signal output portion radiating the jamming signal toward the abnormal attachment.

The jamming signal output portion may include an induction coil for outputting the jamming signal as a magnetic field.

The device may further include a warning portion warning attachment of an abnormal attachment when the abnormal attachment is attached to the card insertion portion.

The device may further include a warning portion warning attachment of an abnormal attachment when the abnormal attachment is attached to the card insertion portion.

The warning portion may include at least one of a vibration warning portion including a vibration motor, a visual warning portion including a light emission lamp, and an auditory warning portion including a buzzer.

The warning portion may include at least one of a vibration warning portion including a vibration motor, a visual warning portion including a light emission lamp, and an auditory warning portion including a buzzer.

According to one or more embodiments, a magnetic stripe (MS) card anti-hacking method includes determining whether a card hacking device for replicating an MS card is attached to a financial service apparatus in which the MS card is used, and preventing replication of the MS card by the card hacking device by generating a jamming signal when the card hacking device is determined to be attached to the financial service apparatus.

The jamming signal may be a magnetic field signal generated by a magnetic induction coil.

When the card hacking device is connected to the financial service apparatus, a warning portion may generate a warning signal.

When the card hacking device is attached to the financial service apparatus, a warning portion may generate a warning signal.

The present inventive concept employs an electronic anti-hacking method, which is not a mechanical hacking prevention method of simply detaching an abnormal attachment when the abnormal attachment adheres to a card insertion portion of a card reader. In other words, when an abnormal deposit is attached, a strong jamming signal is emitted to a hacking head, which may be embedded in the abnormal attachment, thereby preventing normal reading of card information. Apart from this, card users may be warned by vibration, sound, or a visual warning part to further prevent hacking.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates an example of a card insertion portion of an automated teller machine (ATM), that is, a financial automation device which is one of financial service apparatuses;

FIG. 2 illustrates a card hacking device attached to the financial automation device of FIG. 1;

FIG. 3 is a schematic block diagram of an anti-hacking device according to the present inventive concept;

FIG. 4 is a flowchart describing an operation of an anti-hacking method according to the present inventive concept;

FIG. 5 schematically illustrates a substrate and a frame having a slot, into which a magnetic stripe (MS) card is inserted, of an MS card reader employing the anti-hacking device according to the present inventive concept;

FIG. 6 illustrates an anti-hacking device of a bezel type corresponding to a card insertion portion having a card insertion hole as the anti-hacking device according to the present inventive concept;

FIG. 7 illustrates arrangement positions of a sensor and a jamming signal output portion of the anti-hacking device according to the present inventive concept, which are installed corresponding to a hacking device; and

FIG. 8A illustrates a normal read signal of an MS head, and FIG. 8B illustrates a jamming signal.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a method and device for preventing hacking of a magnetic stripe (MS) card according to the present inventive concept is described with reference to the accompanying drawings.

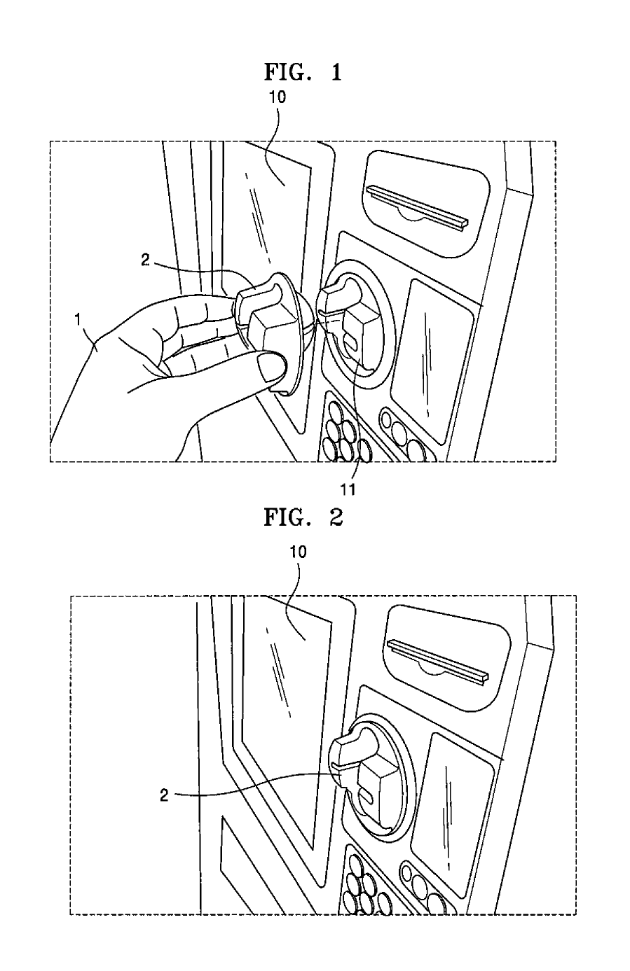

FIG. 1 illustrates an example of a card insertion portion of an automated teller machine (ATM). The ATM is a financial automation device, which is one of financial service apparatuses.

In FIG. 1, a card hacking device 2 is held by a hand 1. The card hacking device 2 is an abnormal attachment. As illustrated in FIG. 1, the card hacking device 2 has a shape that is very similar to the shape of a card insertion portion (bezel) 11 provided in a main body of an ATM, and has a structure to be mounted over the card insertion portion 11.

FIG. 2 illustrates the card hacking device 2 attached to the ATM of FIG. 1. As illustrated in FIG. 2, the card hacking device 2 looks very similar to the card insertion portion 11 that is normal. Accordingly, a card user may insert a card in the card hacking device 2 without knowing.

When a card is inserted in the card hacking device 2, a card reader for hacking provided in the card hacking device first reads card information and stores the information.

The present inventive concept provides an MS card anti-hacking method and a device employing the method, whereby, when the card hacking device 22, that is the, abnormal attachment, is mounted on the card insertion portion 11 that is normal, such a fact is automatically detected and thus card information hacking may be prevented.

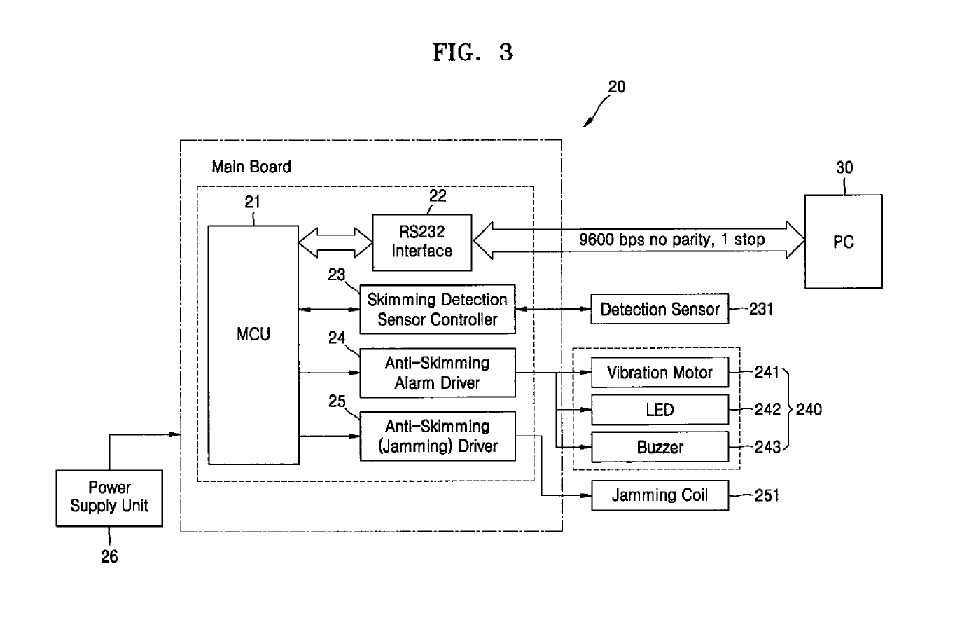

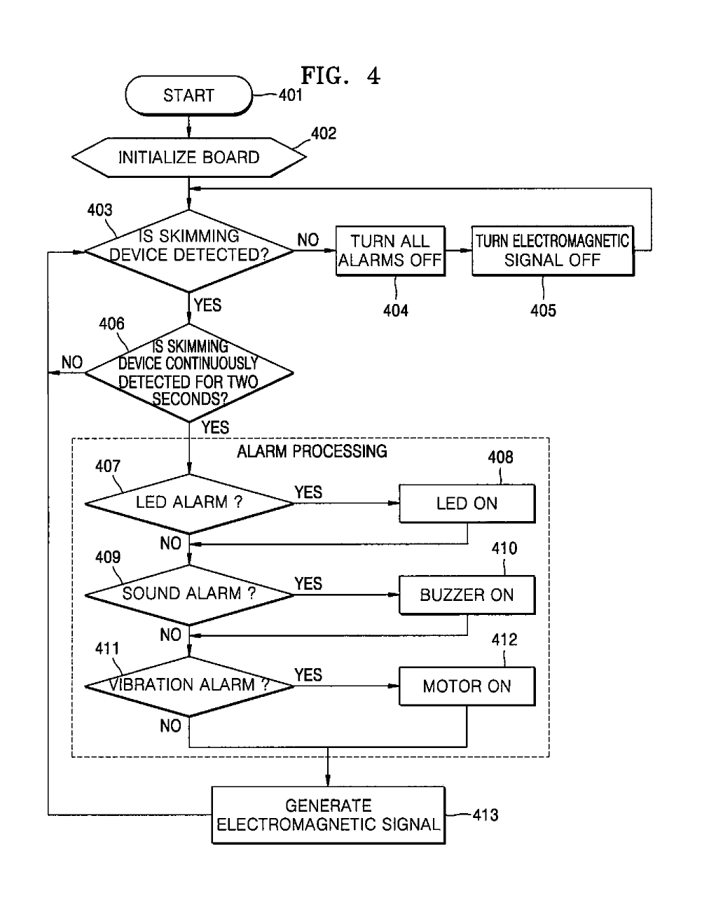

FIG. 3 is a schematic block diagram of an anti-hacking device 20 of an MS card according to the present inventive concept.

A micro controller unit (MCU) 21 of a mainboard is connected to an external computer 30 for management via a communication interface 22 such as RS232 interface. The external computer (PC) 30 may include functions of changing or controlling attributes of the anti-hacking device 20. A power supply unit 26 supplies electric power for operation of the micro controller unit 21.

The anti-hacking device 20 according to the present embodiment may include a detection sensor 231 for detecting or sensing attachment of a hacking device and a skimming detection sensor controller 23 for determining the attachment of a hacking device in response to a signal generated output by the detection sensor 231. The skimming detection sensor controller 23 determines the attachment of a hacking device in real time and transmits a result to the MCU 21.

The anti-hacking device 20 according to the present embodiment may include an anti-skimming alarm driver 24 operating according to the attachment of a hacking device as above and a warning portion 240 operated by the anti-skimming alarm driver 24, and an anti-skimming (jamming) driver 25 generating a jamming signal to interfere with signal processing such as reading of normal card information when the card hacking device 2 is attached to an ATM, and a jamming signal output portion 251 operated by the anti-skimming (jamming) driver 25 and outputting a jamming signal.

The detection sensor 231 may have various forms. For example, any sensor capable of detecting hacking when a bezel type hacking device is mounted over a normal card insertion portion may be used. In the present embodiment, an infrared sensor for optically detecting hacking may be employed. The technical scope of the present inventive concept is not limited by the type of the sensor.

The warning portion 240 may include at least one of a vibration motor 241 that is a vibration warning portion, an LED 242 that is a visual warning portion, and a buzzer 243 that is an auditory warning portion, preferably including all warning portions 241, 242, and 243.

The anti-skimming (jamming) driver 25 generates a signal to interfere with abnormal reading and storing of MS card information by the hacking device, and the jamming signal output portion 251 radiates the signal to a magnetic head of the hacking device and a peripheral circuit thereof.

The jamming signal may have any form of a pattern if it can disable a pulse signal generated by the magnetic head. For example, there may be a method of canceling a relatively weak signal of the head by generating an electrical signal or a magnetic field that maintains a very high energy state while the card is inserted in. Alternatively, a high-frequency pulse that simply repeats low and high states may be radiated to the hacking device, thereby preventing hacking of the card information.

The jamming signal defined by the present inventive concept is to interfere with reading of the card information by the hacking device, and may have various forms of patterns in addition to the above-described pattern. Accordingly, the technical scope of the present inventive concept is not limited by the jamming signal of a specific pattern or type.

FIG. 4 is a flowchart describing an operation of an MS card anti-hacking device and method according to the present inventive concept.

When an operation starts with supply of power (401), a system board is initialized (402). In this state, in a normal state, operations 403, 404, and 405 are sequentially and endlessly repeated.

In other words, in the operation 403, whether a hacking device is attached to an ATM is determined. If a result of the determination is false (No), flags (setting states) for all warnings of the operation 404 are off or reset to a zero bit. Also, in the operation 405, a jamming signal output flag is off or reset to a zero bit. The reset of a flag may include interruption of the current warning operation and jamming signal outputting.

When the attachment of the hacking device is determined in the operation 403 and the determination result is true (Yes), the hacking device is continuously detected for a predetermined time to reconfirm the result of the true (Yes). If the result is still true (Yes), operations 407, 409, and 411 are sequentially performed. Otherwise, that is, the result is false (No), not true (Yes), the method returns to the above-described operation 403.

In an operation 406, when the hacking device is finally determined to have been attached to the ATM, flag (bit) states of LED warning, sound warning, and vibration warning are checked by passing through the operations 407, 409, and 411, and when each bit is set to be a high state, an appropriate warning portion is operated (408, 410, and 412).

After passing through the above process, the anti-hacking device finally generates an electrical or electromagnetic jamming signal and radiates the signal to the hacking device. The jamming signal may be a magnetic signal by a magnetic induction coil according to an embodiment. In this case, a strong jamming magnetic field is formed in the head of the hacking device. Accordingly, reading normal card information, that is, hacking, by the hacking device is impossible.

In the description of the above embodiment, the process of the operations 407, 409, 411, and 413 is performed within a very short time. According to another embodiment, the operation 413, that is, an electromagnetic signal generation operation may precede the alarm processing processes 407, 409, and 411.

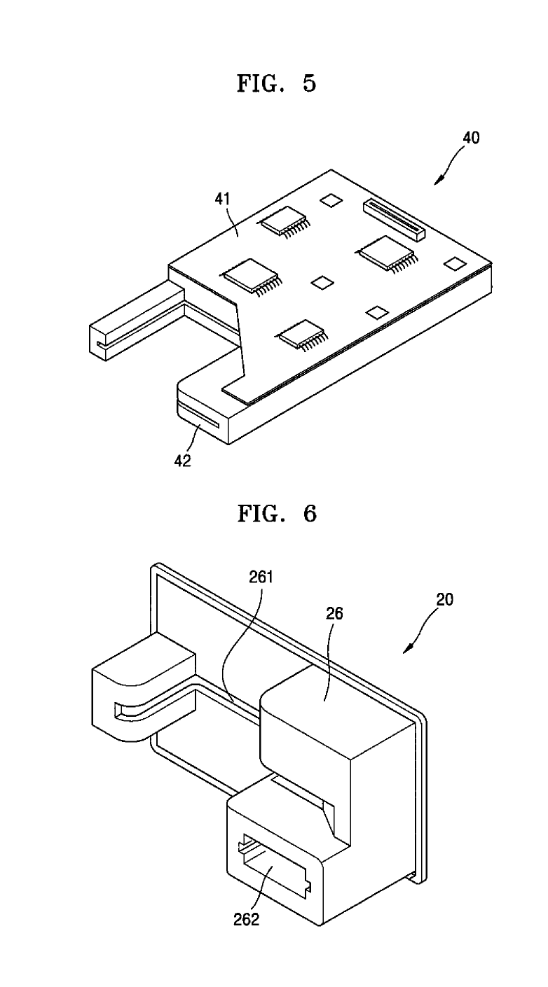

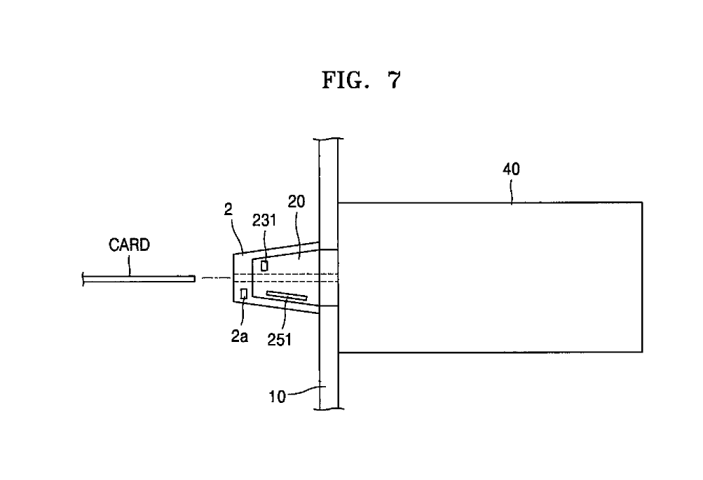

FIG. 5 schematically illustrates a substrate 41 and a frame 42 having a slot, into which a magnetic stripe (MS) card is inserted, of an MS card reader 40 employing the anti-hacking device according to the present inventive concept. FIG. 6 illustrates an anti-hacking device of a bezel type corresponding to a card insertion portion having a card insertion hole as the anti-hacking device according to the present inventive concept.

The anti-hacking device according to the present embodiment is installed at a card insertion portion into which an MS card is inserted, and is exposed to the outside of a financial service apparatus. The anti-hacking device of the present embodiment provides a path through which the MS card may enter the inside of a card reader. Since the detection sensor 231 is provided in a body of the anti-hacking device, as illustrated in FIG. 1 or 2, the detection sensor 231 detects that the hacking device 2 is mounted over the anti-hacking device, and a warning and jamming signal starts to be output according to the process illustrated in FIG. 4.

In the descriptions of FIGS. 5 and 6, it may be seen that a substrate 41 of the MS card reader 40 is independent of the anti-hacking device 20. However, according to another embodiment, a circuit of the anti-hacking device 20 according to the present embodiment may be designed on the substrate 41 of the card reader 40. In this case, only the detection sensor 231 and the jamming signal output portion 251 may be installed in a main body of the anti-hacking device 20 having a bezel shape. In this case, the jamming signal output portion 251 forming a jamming magnetic field by using a magnetic induction coil is arranged to form a magnetic field in an area where the reader of a hacking device may be installed.

FIG. 7 illustrates arrangement positions of the detection sensor 231 and the jamming signal output portion 251 of the anti-hacking device according to the present inventive concept, which are installed corresponding to the hacking device 2.

Referring to FIG. 7, the MS card reader 40 is located inside a main body 1 of a financial service apparatus, and the anti-hacking device 20 having a front bezel, that is, the card insertion portion is installed to be exposed to the outside of the main body 1. The detection sensor 231 and the jamming signal output portion 251 are provided in the anti-hacking device 20. The detection sensor 231 may be installed at a position where the detachment of the hacking device may be detected, for example, in a front surface of a direction in which a card is inserted as illustrated in FIG. 7. The jamming signal output portion 251 is provided at a position where a magnetic field may be formed in a head 2a of the hacking device 2. Such an arrangement of parts is merely an example and the parts may be arranged in various forms.

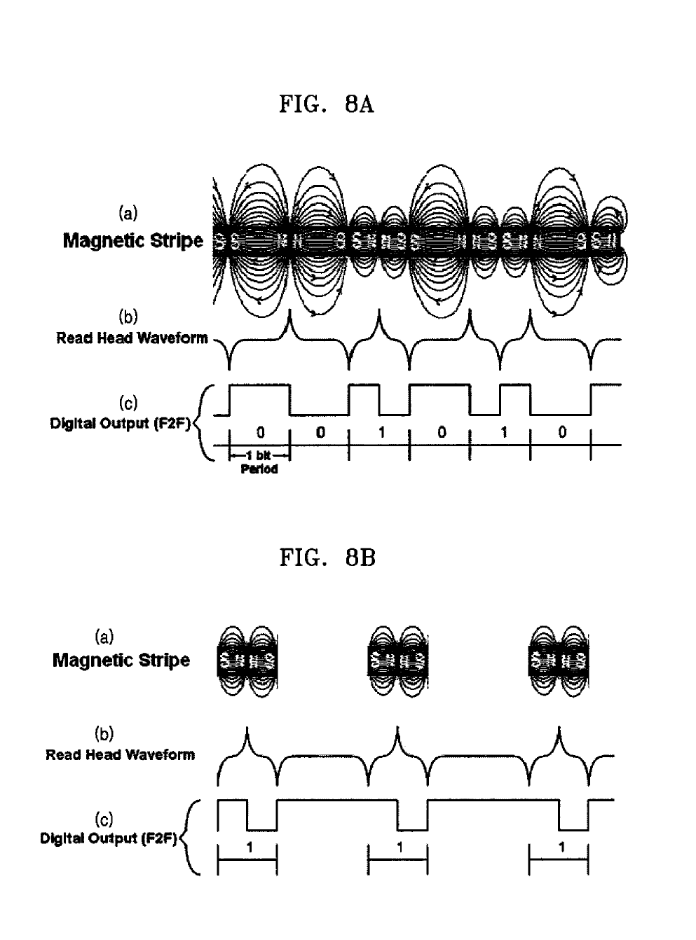

FIG. 8A illustrates a normal read signal of an MS head, and FIG. 8B illustrates a signal for jamming.

In FIG. 8A, a) shows a magnetic field distribution in a magnetic stripe, and b) shows an output signal (wave form) of an MS head obtained from the MS.

In FIG. 8A, c) shows a digital signal F2F finally obtained from the output signal. As illustrated in c) of FIG. 8A, when a signal is entirely high in one bit, a value “0” is obtained, and when a signal has a waveform of low-high or high-low in one bit, a value of “1” is obtained.

According to the above result, as the MS head generates the jamming signal as an interference signal that prevents obtaining a value of “0” or “1” in one bit as described above, illegal card replication by the hacking device may be prevented.

In FIG. 8B illustrating an example of a jamming signal, a) shows a magnetic field distribution in a virtual MS for jamming. Here, a magnetic field is not continuously formed in a cyclic unit and an area without the magnetic field exists. In an area with a magnetic field, a magnetic field distribution of low-high or high-low is in one cycle, which may be used as a magnetic field for jamming. In other words, a magnetic field distribution that is not obtainable from a normal MS is formed as a jamming magnetic field.

In FIG. 8B, b) shows an output signal (wave form) of the MS head of the hacking device by the jamming magnetic field and c) shows a digital signal F2F finally obtained from the output signal. As illustrated in c) of FIG. 8B, the digital signal obtained by the hacking device does not have a value of, for example, “001010”, in which “0” and “1” selectively continues, but has a value “1 1 1”, in which the value of “0” or “1” is missing in the middle as illustrated. Consequentially, the hacking device may not hack normal data from an original MS card.

It should be understood that the embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A magnetic stripe (MS) card anti-hacking device provided in a financial service apparatus including an MS card reader, the MS card anti-hacking device comprising:
a sensor detecting whether an abnormal attachment is attached to a card insertion portion of the MS card reader;
a sensor controller determining whether the abnormal attachment is attached to the card insertion portion by processing a signal received from the sensor;
an anti-skimming (jamming) driver generating a jamming signal to interfere with replication of an MS card when the abnormal attachment is attached to the card insertion portion; and
a jamming signal output portion radiating the jamming signal toward the abnormal attachment.

2. The device of claim 1, wherein the jamming signal output portion comprises an induction coil for outputting the jamming signal as a magnetic field.

3. The device of claim 2, further comprising a warning portion warning attachment of an abnormal attachment when the abnormal attachment is attached to the card insertion portion.

4. The device of claim 1, further comprising a warning portion warning attachment of an abnormal attachment when the abnormal attachment is attached to the card insertion portion.

5. The device of claim 4, wherein the warning portion comprises at least one of a vibration warning portion including a vibration motor, a visual warning portion including a light emission lamp, and an auditory warning portion including a buzzer.

6. The device of claim 2, wherein the warning portion comprises at least one of a vibration warning portion including a vibration motor, a visual warning portion including a light emission lamp, and an auditory warning portion including a buzzer.

7. A magnetic stripe (MS) card anti-hacking method comprising:
determining whether a card hacking device for replicating an MS card is attached to a financial service apparatus in which the MS card is used; and
preventing replication of the MS card by the card hacking device by generating a jamming signal when the card hacking device is determined to be attached to the financial service apparatus.

8. The method of claim 7, wherein the jamming signal is a magnetic field signal generated by a magnetic induction coil.

9. The method of claim 8, wherein, when the card hacking device is connected to the financial service apparatus, a warning portion generates a warning signal.

10. The method of claim 7, wherein, when the card hacking device is attached to the financial service apparatus, a warning portion generates a warning signal.
